(19) United States
(12) Patent Application Publication
(10) Pub. No.: US 2018/0255360 A1
(43) Pub. Date: Sep. 6, 2018

(54) Simulation Method and Apparatus for Watching Together in Live Broadcast

(71) Applicants: LE HOLDINGS (BEIJING) CO., LTD, Beijing (CN); LE SHI INTERNET INFORMATION & TECHNOLOGY CORP., BEIJING, Beijing (CN)

(72) Inventor: Liang LI, BEIJING (CN)

(73) Assignees: Le Holdings (Beijing) Co., Ltd., Beijing (CN); LE SHI INTERNET INFORMATION & TECHNOLOGY CORP., BEIJING, Beijing (CN)

(21) Appl. No.: 15/120,463

(22) PCT Filed: May 26, 2016
(86) PCT No.: PCT/CN2016/083542

§ 371 Date: Aug. 19, 2016

(30) Foreign Application Priority Data
Nov. 30, 2015 (CN) 201510857522.8

(51) Int. Cl. H04N 21/4788; H04L 29/06; G06F 3/0482; G06F 3/16; G06F 3/0486

(52) U.S. Cl. CPC H04N 21/4788; H04L 65/1069; H04L 65/403; G06F 3/0486; G06F 3/0482; G06F 3/167; H04L 65/4015

(57) ABSTRACT

Disclosed is a simulation method and apparatus for watching together in live broadcast, including: acquiring a launching instruction acted on a live broadcast interface to select a target user; sending a watching together invitation to the target user; according to a confirmation response to the watching together invitation returned from the target user, establishing a video chat connection with the target user; and creating a display window at a preset position of the live broadcast interface to display a video chat screen. A friend who wants to watch the live broadcast together can be selected as a target user on the live interface of the live broadcast based on the user's choice, thereby the user can see an image of the friend watching together without switching to other software or leaving the live broadcast interface and perform an interaction such as chat, comment, etc.

### CROSS-REFERENCE TO RELATED APPLICATIONS

This application is a continuation of International Application No. PCT/CN2016/083542, with an international filing date of filed May 26, 2016, which is based upon and claims priority to Chinese Patent Application No. 2015108575228, filed on Nov. 30, 2015, the entire contents of all of which are incorporated herein by reference.

### TECHNICAL FIELD

The present invention relates to live broadcast technology, in particular to a simulation method and apparatus for watching together in live broadcast.

### BACKGROUND

Currently, many users may choose a terminal device to watch a live broadcast of a largescale site activity. When watching a live broadcast of some special types activity such as a sports event, a cultural activity, etc., it is a preferred watch way corresponding to the common watch custom that a plurality of users having the same interest watch, chat and comment together during watching. However, the present way of users watching the live broadcast via respective terminal device is difficult to achieve the together watch. Although a user can chat with other users during watching the live broadcast by the third party devices and software, it needs additional operations outside the live broadcast interface of the live broadcast, and the procedure is complicated and may affect the user's watching process to cause the user miss the live contents.

### SUMMARY

In view of this, an object of the present disclosure provides a simulation method and apparatus for watching together in live broadcast which has a quick and simple operation process without causing much affection to users' watching process.

Based on the above described object, the present disclosure provides a simulation method for watching together in live broadcast, the method as an embodiment includes:

at an electronic device:
acquiring a launching instruction acted on a live broadcast interface and selecting a target user;
sending a watching together invitation to the target user;
according to a confirmation response to the watching together invitation returned from the target user, establishing a video chat connection with the target user; and
creating a display window at a preset position of the live broadcast interface to display a video chat screen.

In some embodiments, the method further includes:

creating multiple user icons on the live broadcast interface in advance and establishing a correspondence between the user icons and the users and creating a user list for accommodating the multiple user icons, wherein the launching instruction is a selecting operation to the user icons.

In some embodiments, wherein selecting a target user further includes:

according to the launching instruction, calling the correspondence between the user icons and the users; and
selecting the user corresponding to the user icon selected by the launching instruction as the target user.
In some embodiments, creating the user list further includes:
creating a marking button; if detecting that there is an operation acted on the marking button, displaying the user list; otherwise, hiding the user list; wherein the operation acted on the marking button includes: a clicking, rolling in or hovering on the marking button input by the user.

In some embodiments, the method further includes:

obtaining an acquisition value by acquiring a voice volume level input by the local user in real time;
comparing the acquisition value with a predetermined threshold; and
if determining that the acquisition value is larger than the predetermined threshold, displaying the user list and generating a prompt.

In some embodiments, the method further includes:

acquiring a drag-and-drop operation on the display window;
recording the end position of the drag-and-drop operation; and
positioning the display window at the end position of the drag-and-drop operation.

In some embodiments, the method further includes:

extracting a voice from a data stream of the video chat connection;
if being not able to extract a voice within a predetermined time interval, then hiding the display window; and
if extracting a voice from the data stream, then displaying the display window.

Another aspect of the present disclosure also provides a simulation apparatus for watching together in live broadcast, as an embodiment includes:

a selecting module, configured to acquire a launching instruction acted on a live broadcast interface and select a target user;
a sending module, configured to send a watching together invitation to the target user;
a connecting module, configured to establishing a video chat connection with the target user according to a confirmation response to the watching together invitation returned from the target user; and
an executing module, configured to create a display window at a preset position of the live broadcast interface to display a video chat screen.

In some embodiments, the apparatus further includes: a creating module, configured to create multiple user icons on the live broadcast interface in advance and establish a correspondence between the user icons and the users and create a user list for accommodating the multiple user icons, wherein the launching instruction is a selecting operation to the user icons.

In some embodiments, the sending module is configured to: call the correspondence between the user icons and the users according to the launching instruction; and select the user corresponding to the user icon selected by the launching instruction as the target user.

In some embodiments, the creating module is configured to: create a marking button; if detecting that there is an operation acted on the marking button, display the user list; otherwise, hide the user list; wherein the operation acted on the marking button includes: a clicking, rolling in or hovering on the marking button input by the user.

In some embodiments, the apparatus further includes:

an acquiring module, configured to obtain an acquisition value by acquiring a voice volume level input by the local user in real time;
a comparing module, configured to compare the acquisition value with a predetermined threshold; and
a prompting module, configured to display the user list and generating a prompt if determining that the acquisition value is larger than the predetermined threshold.

In some embodiments, the executing module is further configured to: according a drag-and-drop operation on the display window, position the display window at the end position of the drag-and-drop operation.

In some embodiments, the apparatus further includes:

an extracting module, configured to extract a voice from a data stream of the video chat connection.
The executing module is configured to: if being not able to extract a voice within a predetermined time interval, hide the display window; and if extracting a voice from the data stream, then display the display window.

Another aspect of the present disclosure also provides a device, as an embodiment includes:

one or more processor(s); and
a memory for storing an operating instruction;
wherein the one or more processor(s) is/are configured to acquire the operation instruction from the memory to execute:
acquiring a launching instruction acted on a live broadcast interface and selecting a target user;
sending a watching together invitation to the target user;
according to a confirmation response to the watching together invitation returned from the target user, establishing a video chat connection with the target user; and
creating a display window at a preset position of the live broadcast interface to display a video chat screen.

In some embodiments, the processor further executes:

creating multiple user icons on the live broadcast interface in advance and establishing a correspondence between the user icons and the users and creating a user list for accommodating the multiple user icons, wherein the launching instruction is a selecting operation to the user icons.

In some embodiments, the processor further executes:

according to the launching instruction, calling the correspondence between the user icons and the users; and
selecting the user corresponding to the user icon selected by the launching instruction as the target user.

In some embodiments, the processor further executes:

creating a marking button; if detecting that there is an operation acted on the marking button, displaying the user list; otherwise, hiding the user list; wherein the operation acted on the marking button includes: a clicking, rolling in or hovering on the marking button input by the user.

In some embodiments, the processor further executes:

obtaining an acquisition value by acquiring a voice volume level input by the local user in real time;
comparing the acquisition value with a predetermined threshold; and
if determining that the acquisition value is larger than the predetermined threshold, displaying the user list and generating a prompt.

In some embodiments, the processor further executes:

acquiring a drag-and-drop operation on the display window;
recording the end position of the drag-and-drop operation; and
positioning the display window at the end position of the drag-and-drop operation.

In some embodiments, the processor is further executes:

extracting a voice from a data stream of the video chat connection;
if being not able to extract a voice within a predetermined time interval, then hiding the display window; and
if extracting a voice from the data stream, then displaying the display window.

Another aspect of the present disclosure also provides a non-transitory computer-readable storage medium storing executable instructions, when executed by an electronic device, cause the electronic device to:

acquire a launching instruction acted on a live broadcast interface to select a target user;
send a watching together invitation to the target user;
according to a confirmation response to the watching together invitation returned from the target user, establish a video chat connection with the target user; and
create a display window at a preset position of the live broadcast interface to display a video chat screen.

In some embodiments, the non-transitory computer-readable storage medium storing executable instructions further causing the electronic device to:

create multiple user icons on the live broadcast interface in advance and establish a correspondence between the user icons and the users, and create a user list for accommodating the multiple user icons, wherein the launching instruction is a selecting operation to the user icons.

In some embodiments, the non-transitory computer-readable storage medium storing executable instructions further causing the electronic device to:

according to the launching instruction, call the correspondence between the user icons and the users; and
select the user corresponding to the user icon selected by the launching instruction as the target user.

In some embodiments, the non-transitory computer-readable storage medium storing executable instructions further causing the electronic device to:

create a marking button; if detect that there is an operation acted on the marking button, display the user list; otherwise, hide the user list; wherein the operation acted on the marking button includes a clicking, rolling in or hovering on the marking button input by the user.

In some embodiments, the non-transitory computer-readable storage medium storing executable instructions further causing the electronic device to:

obtain an acquisition value by acquiring a voice volume level input by the local user in real time;
compare the acquisition value with a predetermined threshold; and
if determine that the acquisition value is larger than the predetermined threshold, display the user list and generate a prompt.

In some embodiments, the non-transitory computer-readable storage medium storing executable instructions further causing the electronic device to:

extract a voice from a data stream of the video chat connection;
if being not able to extract a voice within a predetermined time interval, then hide the display window; and
if extract a voice from the data stream, then display the display window.

As can be seen from the above, according to the simulation method and apparatus for watching together in live broadcast provided by the embodiments of the disclosure, a user can select a friend who wants to watch the live broadcast together as a target user on the live interface of the live broadcast based on the user's choice. A video chat connection with the target user is established, and the video chat screen is displayed on a display window within the live broadcast interface, to allow the user to see an image of the friend watching together without switching to other software or leaving the live broadcast interface and perform an interaction such as chat, comment, etc., at the time of watching the live broadcast, so as to achieve a simple and quick simulation effect of watching live broadcast together.

It should be understood that both the descriptions in general and in detailed are exemplary and explanatory without any limit to the disclosure.

### BRIEF DESCRIPTION OF THE DRAWINGS

In order to more clearly illustrate the embodiments of the present disclosure, the drawings as required for illustrating the embodiments will be described in brief. Apparently, the drawings described below are merely some embodiments of the present disclosure, and for the ordinary skilled in the art can learn from the drawings without creative efforts.

FIG. 1 is a schematic flow diagram of a simulation method for watching together in live broadcast according to an embodiment of the present disclosure;

FIG. 2 is a schematic flow diagram of a simulation method for watching together in live broadcast according to another embodiment of the present disclosure;

FIG. 3 is a schematic view of a simulation apparatus for watching together in live broadcast according to an embodiment of the present disclosure;

FIG. 4 is a schematic view of a simulation apparatus for watching together in live broadcast according to an embodiment of the present disclosure.

The embodiments of the present disclosure have been clearly illustrated through the drawings and will be described in detail hereinafter. These drawings and text description are not intent in any way to limit the scope of the disclosure, but illustrate the concept of the disclosure for the skilled in the art by reference to specific embodiments.

### DETAILED DESCRIPTION

The present disclosure is described more fully hereinafter with reference to the accompanying drawings so that the objects, technical solutions and advantages of the present disclosure will become more apparent.

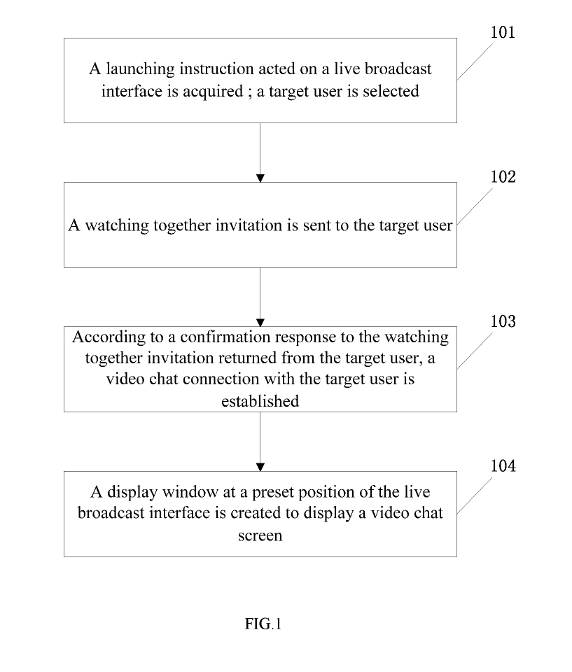

Referring to FIG. 1, it is a schematic flow diagram of a simulation method for watching together in live broadcast according to an embodiment of the present disclosure.

The simulation method for watching together in live broadcast includes the following steps.

In step 101, a launching instruction acted on a live broadcast interface is acquired; a target user is selected.

On the live broadcast interface, a live broadcast screen area occupies a main portion and there are some common functional buttons arranged on the area outside the live broadcast screen area. In this embodiment, a group of buttons for the launching user (one party launching the watching together, namely the operator in the embodiment) to select the object watching together are arranged on the live broadcast interface. The buttons in the group correspond to different other users respectively. The term “other users” used herein refers to the other users using the same way to watch the live broadcast as the launching user. The launching user inputs a launching instruction and selects a target user with whom the launching user wants to watch the live broadcast together according to the correspondence between a button of the group of buttons and the other users after the launching instruction is acquired.

In step 102, a watching together invitation is sent to the target user.

After selecting the target user, a watching together invitation is sent to the target user. After the watching together invitation is sent to the target user, it will prompt the target user that there is a launching user want to invite him to watch the current live broadcast together and inquire whether the target user agrees to the watching together invitation. If the target user agrees to the watching together invitation, then a confirmation response is returned to the lunching user; and if the target user does not agree to the watching together invitation, then a refusing response is returned to the lunching user.

In step 103, according to a confirmation response to the watching together invitation returned from the target user; a video chat connection with the target user is established.

When the target user agrees to the watching together invitation and returns a confirmation response, a video chat connection with the target user is established based on the confirmation response. The video chat connection typically is established by using a chat service provided by the special chat server.

In step 104, a display window at a preset position of the live broadcast interface is created to display a video chat screen.

After establishing the video chat connection with the target user, a display window for displaying the video chat screen is created on the live broadcast interface. The display window is arranged at a preset position of the live broadcast interface, typically in a striking area outside the live broadcast screen area on the live broadcast interface, such as at a position parallel to a side of the live broadcast screen area.

As can be seen from the abovementioned embodiment, the simulation method for watching together in live broadcast provided by the embodiment of the disclosure can allow the user to quickly select a target user and create a display window to video chat in the live broadcast interface while watching the live broadcast, so that the user does not have to use any third party software in the whole process or leave the live broadcast interface. It can ensure the continuity of the user's watching live broadcast and provide a simulation circumstance in which watching live broadcast together with friends.

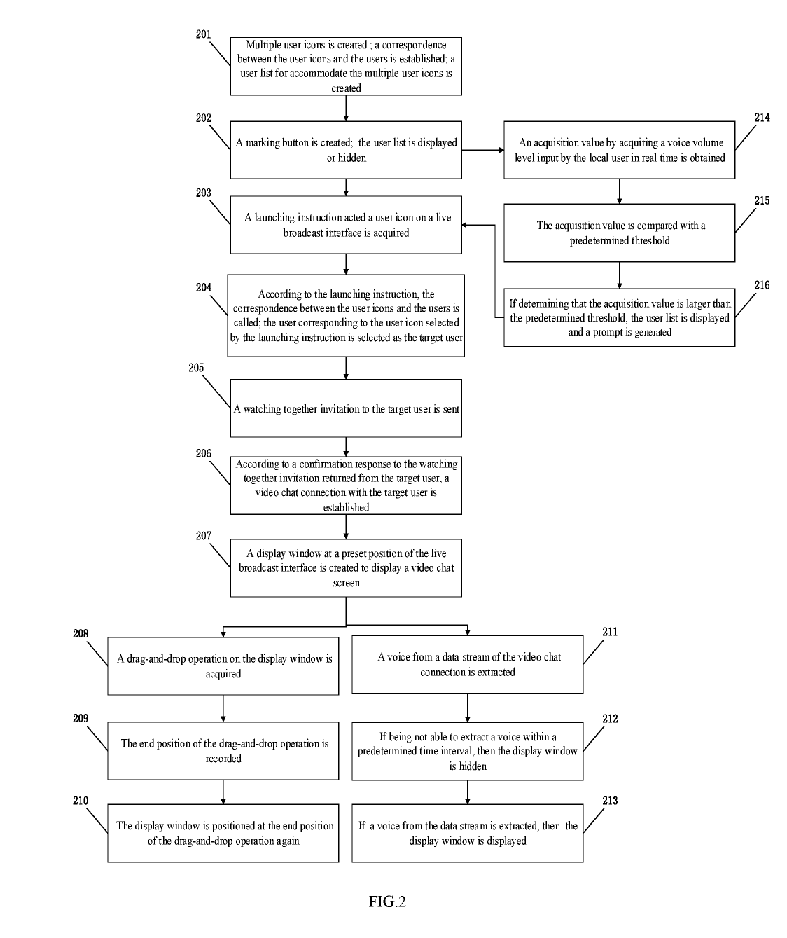

Hereinafter, a method for prompting key points in live broadcast according to an embodiment of the present disclosure will be further described by a specific example of the present disclosure. Referring to FIG. 2, it is a schematic flow diagram of a simulation method for watching together in live broadcast according to another embodiment of the present disclosure.

The simulation method for watching together in live broadcast includes the following steps:

In step 201, multiple user icons on the live broadcast interface in advance is created; a correspondence between the user icons and the users is established; a user list for accommodating the multiple user icons is created, wherein the launching instruction is a selecting operation to the user icons.

This step is an initial step of the live broadcast interface for creating multiple user icons on the live broadcast interface and creating a user list for accommodating the multiple user icons, by which the user input the launching instruction. In this embodiment, all the users register in an existing user administration system to obtain a legal permission of watching live broadcast and the users can add a friend to each other in the user administration system based on the real relations. In this step, as for the live broadcast interface of the launching user, multiple user icons are created firstly, and then a correspondence between the multiple user icons and different other users are created. The other users are friends of the launching user and watching the same live broadcast. Different user icons can be discerned by the suffix username of the user icons and the username can be directly called from the user administration system and generated. Finally, a user list for accommodating the multiple user icons is created to make the multiple user icons regularly arranged and displayed on the live broadcast interface. The user icons are operable objects and the launching user can perform a selecting operation on the user icons to achieve the input of a launching instruction.

In step 202, a marking button is created; if there is an operation acted on the marking button is detected, the user list is displayed; otherwise, the user list is hidden; wherein the operation acted on the marking button includes: a clicking, rolling in or hovering on the marking button input by the user.

After generating the user list, in order to avoid the interference to the user's watching live broadcast, a display effect is added on the user list. On the live broadcast interface, a marking button corresponding to the user list is created at a preset display position of the user list, and the marking button is used for control display and hide of the user list, namely addition of a display effect to the user list. If an operation acted on the marking button is detected, the user list is displayed; otherwise, the user list is hidden. Specifically, if it is detected that the user performs a clicking, rolling in or hovering operations on the marking button, then the user list is displayed, and a preferred display way is to eject the user list at the position of the marking button. Under the normal status, namely when it is not detected that the user performs an operation on the marking button, the user list is hidden, so as to avoid of attracting too much attention of the user and ensure the user can watch live broadcast better.

Further, after triggering the marking button to display the user list, the user list will be displayed continuously for a preset time for the user to operate. If the user operation on the user list is not detected within a period (typically, several seconds), the user list is hidden.

In step 203, a launching instruction acted a user icon on a live broadcast interface is acquired.

The launching user operates the marking icon to display the user list and then directly implements a selection operation on the user icon in the user list to input a launching instruction. For example, the launching user uses a PC to watch a live broadcast, and when he wants to watch the live broadcast together with user A, he can use a mouse to click the marking icon to display the user list on the live broadcast interface and then click on the user icon of user A in the user list.

In step 204, according to the launching instruction the correspondence between the user icons and the users is called ; the user corresponding to the user icon selected by the launching instruction as the target user is selected.

Based on the selection of the user icon in the user list input by the user, the correspondence established in the initial step is called to select a user corresponding to the user icon as the target user, namely the friend with whom the launching user wants to watch the live broadcast together.

In step 205, a watching together invitation to the target user is sent.

In step 206, according to a confirmation response to the watching together invitation returned from the target user, a video chat connection with the target user is established.

In step 207, a display window at a preset position of the live broadcast interface is created to display a video chat screen.

When the user watches the live broadcast via the live broadcast screen area in the live broadcast interface, he also can see the image of the friend via the video chat screen displayed in the display window, chat and comment on the live broadcast.

In this embodiment, after the display window is created, the method further includes:

In step 208, a drag-and-drop operation on the display window is acquired.

In step 209, the end position of the drag-and-drop operation is recorded.

In step 210, the display window is positioned at the end position of the drag-and-drop operation.

In these steps, the display window is set as an operable object and the user can change its position by operating on it to further adjust the position of the display window according to the user's own watching habit and the current watching situation.

In this embodiment, after the display window is created, the method further includes the following steps.

In step 211, a voice from a data stream of the video chat connection is extracted.

Based on the video chat connection between the launching user and the target user established in the previous step, a voice is extracted from the data stream of the video chat connection to identify whether there is a voice in the current video chat. The voice can be extracted by a common filter unit to filter.

In step 212, if being not able to extract a voice within a predetermined time interval, then the display window is hidden.

A voice is extracted continuously from the data stream to obtain a result of voice extraction;

if no voice can be extracted within the predetermined time, then the display window is hidden.

In step 213, if a voice from the data stream is extracted, then the display window is displayed.

In the status that the display window is hidden, when a voice is extracted from the data stream again, the display window is displayed again.

In these steps, the display window can be hidden while the both users in the current video chat pay attention to the live broadcast without speaking to avoid that the attentions of the users are attracted by the display window and further ensure the watching quality of the users.

During a user watches a live broadcast, when a key live broadcast content appears such as a goal time in football match, the user may spontaneously raise a cheer, and at this time the user may expect to discuss on the key live broadcast content with a friend, so that in this embodiment, after the user list is created, the method further includes:

In step 214, an acquisition value by acquiring a voice volume level input by the local user in real time is obtained.

The voice volume level input by the local user can be acquired in real time by a sound input device of the user terminal, and the acquisition value of the voice volume can accurately reflect the behavior of the user and be used as a criteria for determining that a key live broadcast content appears.

In step 215, the acquisition value is compared with a predetermined threshold.

A predetermined threshold of voice volume level is used as a criteria for determining that a key live broadcast content appears. Then the predetermined threshold of voice volume level is compared with the acquisition value of the voice volume level input by the user.

In step 216, if determining that the acquisition value is larger than the predetermined threshold, the user list is displayed and a prompt is generated.

If determining that the acquisition value is larger than the predetermined threshold, which means that the local user raised a cheer and a key live broadcast content appears, then the display window is displayed from hidden, and a prompt in the form of a prompt textbox or a prompt voice can be sent to the user to prompt the local user to select friends to launch for watching together.

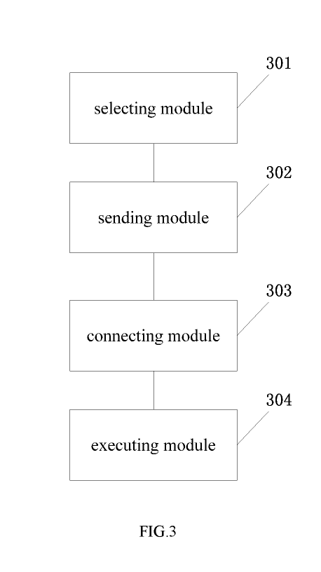

In another aspect, an embodiment of the present disclosure also provides a simulation apparatus for watching together in live broadcast. Referring to FIG. 3, it is a schematic view of a simulation apparatus for watching together in live broadcast according to an embodiment of the present disclosure.

The simulation apparatus for watching together in live broadcast includes:

a selecting module 301, configured to acquire a launching instruction acted on a live broadcast interface and selecting a target user;
a sending module 302, configured to send a watching together invitation to the target user;
a connecting module 303, configured to establish a video chat connection with the target user according to a confirmation response to the watching together invitation returned from the target user; and
an executing module 304, configured to create a display window at a preset position of the live broadcast interface to display a video chat screen.

As can be seen from the embodiment, the simulation apparatus for watching together in live broadcast according to the embodiment of the present disclosure can allow the user to quickly select a target user and create a display window to video chat in the live broadcast interface while watching the live broadcast, so that the user does not have to use any third party software in the whole process or leave the live broadcast interface. It can ensure the continuity of the user's watching live broadcast and provide a simulation circumstance in which watching live broadcast together with friends.

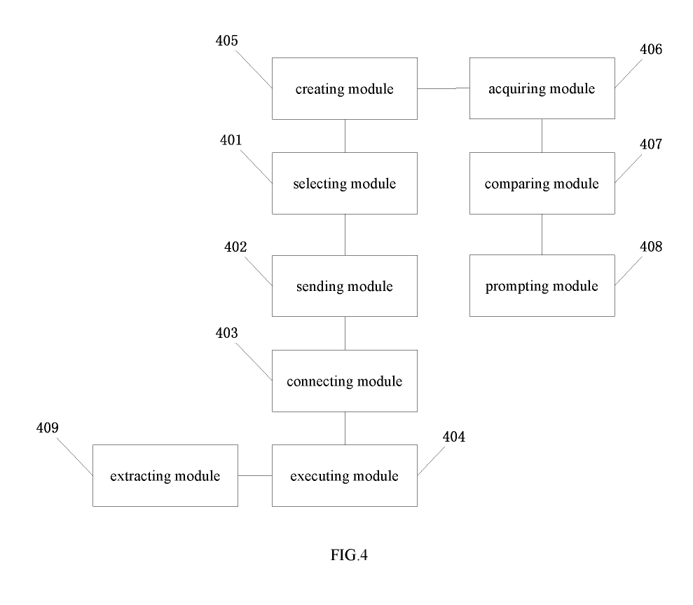

As a specific example, referring to FIG. 4, it is a schematic view of a simulation apparatus for watching together in live broadcast according to an embodiment of the present disclosure.

Preferably, in addition to the selecting module 401, sending module 402, connecting module 403 and executing module 404, the simulation apparatus further includes: a creating module 405, configured to create multiple user icons on the live broadcast interface in advance and establish a correspondence between the user icons and the users and create a user list for accommodating the multiple user icons, wherein the launching instruction received by the selecting module 401 is a selecting operation to the user icons.

Further, the creating module 405 is configured to create a marking icon; when the marking icon is in an operating status, displaying the user list; when the marking icon is in a non-operating status, hiding the user list; wherein the operating status includes: clicking, rolling in or hovering.

The sending module 402 is further configured to: according to the launching instruction, call the correspondence between the user icons and the users; and select the user corresponding to the user icon selected by the launching instruction as the target user.

The executing module is further configured to: according a drag-and-drop operation on the display window, position the display window at the end position of the drag-and-drop operation.

In some other embodiments, the simulation apparatus for watching together in live broadcast further includes:

an acquiring module 406, configured to obtain an acquisition value by acquiring a voice volume level input by the local user in real time;
a comparing module 407, configured to compare the acquisition value with a predetermined threshold; and
a prompting module 408, configured to displaying the user list and generating a prompt if determining that the acquisition value is larger than the predetermined threshold.

In some other embodiments, the simulation apparatus for watching together in live broadcast further includes:

an extracting module 409, configured to extract a voice from a data stream of the video chat connection.

The executing module 404 is further configured to: if being not able to extract a voice within a predetermined time interval, hide the display window; and if extracting a voice from the data stream, then display the display window.

Further another aspect of the present disclosure also provides a device, as an embodiment includes:

one or more processor(s); and
a memory for storing an operating instruction;
wherein the one or more processor(s) is/are configured to acquire the operation instruction from the memory to execute :
acquiring a launching instruction acted on a live broadcast interface and selecting a target user;

sending a watching together invitation to the target user;

according to a confirmation response to the watching together invitation returned from the target user, establishing a video chat connection with the target user; and
creating a display window at a preset position of the live broadcast interface to display a video chat screen.

In some embodiments, the processor further executes:

creating multiple user icons on the live broadcast interface in advance and establishing a correspondence between the user icons and the users and creating a user list for accommodating the multiple user icons, wherein the launching instruction is a selecting operation to the user icons.

In some embodiments, the processor further executes:

according to the launching instruction, calling the correspondence between the user icons and the users; and
selecting the user corresponding to the user icon selected by the launching instruction as the target user.

In some embodiments, the processor further executes:

creating a marking button; only if detecting that there is an operation acted on the marking button, displaying the user list; otherwise, hiding the user list; wherein the operation acted on the marking button includes: a clicking, rolling in or hovering on the marking button input by the user.

In some embodiments, the processor further executes:

obtaining an acquisition value by acquiring a voice volume level input by the local user in real time;
comparing the acquisition value with a predetermined threshold; and
if determining that the acquisition value is larger than the predetermined threshold, displaying the user list and generating a prompt.

In some embodiments, the processor is further used for executing:

acquiring a drag-and-drop operation on the display window;
recording the end position of the drag-and-drop operation; and
positioning the display window at the end position of the drag-and-drop operation.

In some embodiments, the processor further executes:

extracting a voice from a data stream of the video chat connection;
if being not able to extract a voice within a predetermined time interval, then hiding the display window; and
if extracting a voice from the data stream, then displaying the display window.

In addition, typically, the device of the present disclosure can be a variety of electronic terminal devices such as mobile phone, personal digital assistant (PDA), tablet PC (PAD), smart TV, etc., so that the scope of the disclosure should not be limited to a specific type of electronic device. The system of the present disclosure can be applied in any one of the above electronic terminal device in the form of electronic hardware, computer software or a combination thereof.

Furthermore, the method according to the present disclosure may also be implemented as a computer program executed by CPU, and the computer program may be stored in a computer readable storage medium. When the computer program is executed by CPU, the above functions defined in the methods of the present disclosure are executed.

Furthermore, the above described method steps and system units can also be implemented by using a controller and a computer readable storage medium for storing a computer program to make the controller to implement the above steps or unit functions.

Additionally, it should be appreciated that the computer readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As an example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct RambusRAM (DRRAM). The disclosed aspects of the storage devices are intended to include, but not limited to these and other suitable types of memory.

Those skilled in the art will also understand that a combination of the illustrative logical sections, modules, circuits, and algorithm steps described in this disclosure may be implemented as electronic hardware, computer software, or both. To clearly illustrate the interchangeability between hardware and software, various illustrative components, sections, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical sections, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of method or algorithm described herein may be contained directly in hardware, software module executed by a processor, or both. The software module may reside in RAM memory, flash memory, ROM memory, EPROM memory, EEPROM memory, registers, hard disk, removable disk, CDROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer readable medium. Computer readable medium includes both computer storage medium and communication medium, and the communication medium includes any medium contributed to transmit a computer program from one place to another. The storage medium may be any available medium accessible by a general purpose or special purpose computer. As an example without any restriction, the computer readable medium can include RAM, ROM, EEPROM, CDROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CDROM disc (CD), laser disc, optical disc, digital versatile disc (DVD), floppy disk and Blu-ray disc where the disk usually reproduces data magnetically and the disc reproduces data optically with lasers. Combinations of the above should also be included within the scope of computer readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present disclosure, and there are many other variations of the different aspects of the present disclosure as described herein without description in the details for simplicity. Thus, any omissions, modifications, equivalent replacements and improvements made in the spirit and principles of the present disclosure should be included within the scopes of the present disclosure.

What is claimed is:

1. A simulation method for watching together in live broadcast, comprising:
at an electronic device:
acquiring a launching instruction acted on a live broadcast interface to select a target user;
sending a watching together invitation to the target user;
according to a confirmation response to the watching together invitation returned from the target user, establishing a video chat connection with the target user; and
creating a display window at a preset position of the live broadcast interface to display a video chat screen.

2. The method according to claim 1, further comprising:
creating multiple user icons on the live broadcast interface in advance and establishing a correspondence between the user icons and the users, and creating a user list for accommodating the multiple user icons, wherein the launching instruction is a selecting operation to the user icons.

3. The method according to claim 2, wherein selecting a target user further comprising:
according to the launching instruction, calling the correspondence between the user icons and the users; and
selecting the user corresponding to the user icon selected by the launching instruction as the target user.

4. The method according to claim 2, wherein creating a user list further comprising:
creating a marking button; if detecting that there is an operation acted on the marking button, displaying the user list; otherwise, hiding the user list; wherein the operation acted on the marking button comprises a clicking, rolling in or hovering on the marking button input by the user.

5. The method according to claim 4, further comprising:
obtaining an acquisition value by acquiring a voice volume level input by the local user in real time;
comparing the acquisition value with a predetermined threshold; and
if determining that the acquisition value is larger than the predetermined threshold, displaying the user list and generating a prompt.

6. The method according to claim 1, further comprising:
acquiring a drag-and-drop operation on the display window;
recording the end position of the drag-and-drop operation; and
positioning the display window at the end position of the drag-and-drop operation.

7. The method according to claim 1, further comprising:
extracting a voice from a data stream of the video chat connection;
if being not able to extract a voice within a predetermined time interval, hiding the display window; and
if extracting a voice from the data stream, displaying the display window.

8. A device, comprising:
one or more processor(s); and
a memory for storing an operating instruction;
wherein the one or more processor(s) is/are configured to acquire the operation instruction from the memory to execute :
acquiring a launching instruction acted on a live broadcast interface and selecting a target user;
sending a watching together invitation to the target user;
according to a confirmation response to the watching together invitation returned from the target user, establishing a video chat connection with the target user; and
creating a display window at a preset position of the live broadcast interface to display a video chat screen.

9. The device according to claim 8, wherein the processor further executes:
creating multiple user icons on the live broadcast interface in advance and establishing a correspondence between the user icons and the users and creating a user list for accommodating the multiple user icons, wherein the launching instruction is a selecting operation to the user icons.

10. The device according to claim 9, wherein the processor further executes:
according to the launching instruction, calling the correspondence between the user icons and the users; and
selecting the user corresponding to the user icon selected by the launching instruction as the target user.

11. The device according to claim 9, wherein the processor further executes:
creating a marking button; if detecting that there is an operation acted on the marking button, displaying the user list; otherwise, hiding the user list; wherein the operation acted on the marking button comprises a clicking, rolling in or hovering on the marking button input by the user.

12. The device according to claim 11, wherein the processor further executes:
obtaining an acquisition value by acquiring a voice volume level input by the local user in real time;
comparing the acquisition value with a predetermined threshold; and
if determining that the acquisition value is larger than the predetermined threshold, displaying the user list and generating a prompt.

13. The device according to claim 9, wherein the processor further executes:
acquiring a drag-and-drop operation on the display window;
recording the end position of the drag-and-drop operation; and
positioning the display window at the end position of the drag-and-drop operation.

14. The device according to claim 9, wherein the processor further executes:
extracting a voice from a data stream of the video chat connection;
if being not able to extract a voice within a predetermined time interval, hiding the display window; and
if extracting a voice from the data stream, displaying the display window.

15. A non-transitory computer-readable storage medium storing executable instructions that, when executed by an electronic device, cause the electronic device to:
acquire a launching instruction acted on a live broadcast interface to select a target user;
send a watching together invitation to the target user;
according to a confirmation response to the watching together invitation returned from the target user, establish a video chat connection with the target user; and
create a display window at a preset position of the live broadcast interface to display a video chat screen.

16. The non-transitory computer-readable storage medium storing executable instructions according to claim 15, further causing the electronic device to:
create multiple user icons on the live broadcast interface in advance and establish a correspondence between the user icons and the users, and create a user list for accommodating the multiple user icons, wherein the launching instruction is a selecting operation to the user icons.

17. The non-transitory computer-readable storage medium storing executable instructions according to claim 16, further causing the electronic device to:
according to the launching instruction, call the correspondence between the user icons and the users; and
select the user corresponding to the user icon selected by the launching instruction as the target user.

18. The non-transitory computer-readable storage medium storing executable instructions according to claim 16, further causing the electronic device to:
create a marking button; if detect that there is an operation acted on the marking button, display the user list; otherwise, hide the user list; wherein the operation acted on the marking button comprises a clicking, rolling in or hovering on the marking button input by the user.

19. The non-transitory computer-readable storage medium storing executable instructions according to claim 18, further causing the electronic device to:
obtain an acquisition value by acquiring a voice volume level input by the local user in real time;
compare the acquisition value with a predetermined threshold; and
if determining that the acquisition value is larger than the predetermined threshold, display the user list and generate a prompt.

20. The non-transitory computer-readable storage medium storing executable instructions according to claim 15, further causing the electronic device to:
extract a voice from a data stream of the video chat connection;
if being not able to extract a voice within a predetermined time interval, hide the display window; and
if extracting a voice from the data stream, display the display window.
